(19) United States
(12) Patent Application Publication
(10) Pub. No.: US 2001/0047843 A1
(43) Pub. Date: Dec. 6, 2001

(54) Handicraft process for creating cards

(76) Inventor: Maureen Louise Reinig, Monrovia, CA (US)

Correspondence Address: Scott W. Kelley, KELLY BAUERSFELD LOWRY & KELLEY, LLP, Suite 1650, 6320 Canoga Avenue, Woodland Hills, CA, 91367, US

(21) Appl. No.: 09/747,462

(22) Filed: Dec. 22, 2000

Related U.S. Application Data
(60) Provisional application No. 60/171,922, filed on Dec. 22, 1999.

(51) Int. Cl. B44C 1/00

(52) U.S. Cl. 156/63; 156/267

(57) ABSTRACT

A handcraft process for creating cards includes the steps of providing a template having a predetermined configuration of slots which are designated as either folding or cutting slots. The template is aligned with a sheet of material intended to form the card. Folding and cutting marks are formed on the sheet of material using the slots in the template. The sheet of material is cut along the cutting marks, and folded along the folding marks to form the card. A three-dimensional greeting card can be created by connecting portions of the folded material sheet to one another.

### RELATED APPLICATION

This application claims priority from provisional application Ser. No. 60/171,922 filed Dec. 22, 1999.

### BACKGROUND OF THE INVENTION

This invention relates generally to handcrafts. More particularly, the present invention relates to a process of using a template to create decorative greeting cards from card stock.

The preparation required to make unusual handcraft cards from card stock paper involves considerable manual skill and dexterity. This process can be time consuming, especially if done without guide materials. For this reason, a number of books and paper patterns have been developed for making unusual card shape folded greeting cards. However, the crafter can find that the directions associated with such prior paper patterns and books can be difficult to understand. Furthermore, duplicate cards are difficult to produce as the handcrafted card does not come out perfect every time.

Accordingly, there is a continuing need for card templates which allow the crafter to make handcraft cards more quickly. What is also needed is a card template which allow the crafter to make duplicate handcraft cards with precise reproducibility. There is also a need for a template which assists crafters in reproducing greeting cards on paper surfaces that do not already have the pattern provided thereon. There is a further need for a card template which can be used in connection with any color of paper utilizing traditional crafting methods. The present invention fulfills these needs and provides other related advantages.

### SUMMARY OF THE INVENTION

The present invention resides in a process for forming a card, such as a greeting card or handcraft card. This process comprises the steps of first providing a template having a predetermined configuration of slots formed therein. The slots are either designated as folding or cutting slots. A sheet of material is provided. Preferably, the material comprises card stock having patterns imprinted thereon, although it is not limited to such. The template is aligned with the sheet of material and the folding and cutting marks are formed on the sheet of material using the slots and the template. This is typically done using a pencil, stylus or the like. The sheet of material is then cut along the cutting marks formed on the sheet of material. The sheet of material is folded along the folding marks to create the card.

Preferably, the template is comprised of a reusable material, such as plastic or the like. The template may include cutting and folding slots for multiple greeting card designs. Typically, the configuration of the cutting and folding slots formed in the template creates a decorative design in the greeting card after the material is properly cut and folded.

A three-dimensional greeting card may be created by connecting portions of the folded material sheet to one another. Decorations may be attached to the cut and folded sheet of material to further enhance the aesthetic qualities of the card.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompany drawings illustrate the invention. In such drawings:

FIG. 1 is a top plan view of a card-making template embodying the present invention;

FIG. 2 is a perspective view of a sheet of material underlying the card-making template of FIG. 1, and having cutting and folding marks formed thereon according to the template;

FIG. 3 is a perspective view of the sheet of material, illustrating cutting along cutting marks that form a decorative design;

FIG. 4 is a perspective view illustrating the sheet of material being cut along cutting lines formed thereon;

FIG. 5 is a top plan view of the sheet of material having all of the cutting marks appropriately cut;

FIG. 6 is a perspective view of a three-dimensional greeting card formed by folding the sheet of material along folding lines formed thereon;

FIG. 7 is an end view of the greeting card of FIG. 6, having decorations attached to an interior portion thereof; and

FIG. 8 is a perspective view of the greeting card of FIG. 7, wherein the decorations are visible through a cut-out decorative design formed in the greeting card.

### DETAILED DESCRIPTION OF THE PREFERRED EMBODIMENTS

As shown in the drawings for purposes of illustration, the present invention is concerned with a greeting card-making template 10 and related method of preparing card stock into folded greeting cards 12 utilizing the template 10.

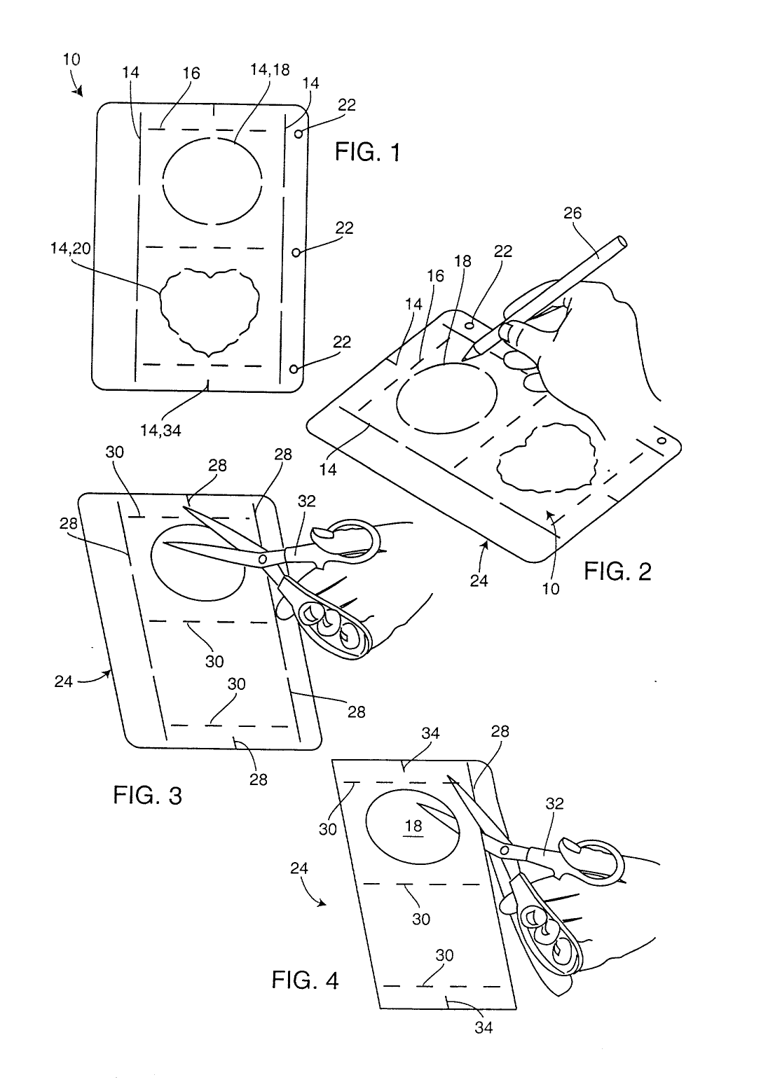

The greeting card-making template 10 is preferably reusable and typically constructed from a semi-rigid transparent or semi-transparent plastic. The template 10 includes markings 14 and 16 in the form of varying length slits through the plastic template 10. Each slit 14 and 16 on the template 10 corresponds with a specific task. For example, longerslit markings 14 indicate cutting lines, while shorter slit markings 16 are indicative of score or folding lines. Other markings, such as small dot apertures (not shown) may be used for pencil markings to match up dots on the card stock which are later glued or otherwise attached to each other. The configuration of cutting and folding slots 14 and 16 formed in the template 10 create a decorative design in the fully constructed greeting card 12. Preferably, the template 10 includes cutting and folding slots 14 and 16 for multiple greeting card designs, such as the oval 18 or heart 20 window illustrated in FIG. 1. The plastic template 10 may also include punch holes 22 so that the crafter can easily store multiple templates 10 within a binder.

In order to create a greeting card 12, the template 10 is placed over a sheet of material 24 which typically comprises background paper, such as card stock or the like. As will be appreciated by the reader, the crafter is not limited in the color or design of the card stock paper utilized. The sheet of material 24 can be aligned with the outermost edge of the template 10, or with the outermost cutting slit 14. A light pencil 26, stylus, or the like is used to form cutting and folding markings 28 and 30 on the sheet of material 24. This is done by tracing the cutting and folding slits 14 and 16.

Typically, the outermost cutting marking lines 28 correspond with the final shape of the folded greeting card 12. The greeting card 12 may include an open window such as the oval window 18 illustrated in FIG. 2. With the illustrated template 10, the crafter could choose between an oval 18 or a heart 20 window. If both the oval and heart 18 and 22 windows were traced, the resulting card would have a window on either side thereof. Scissors 32 or a craft knife or the like is used to cut along the cutting marking lines 28.

If the folding slits 16 were not traced previously, the cut-out sheet of material 24 is realigned with the template 10 and the pencil 26 or the like is used to score along each of the folding short slits 16 to form folding markings 30.

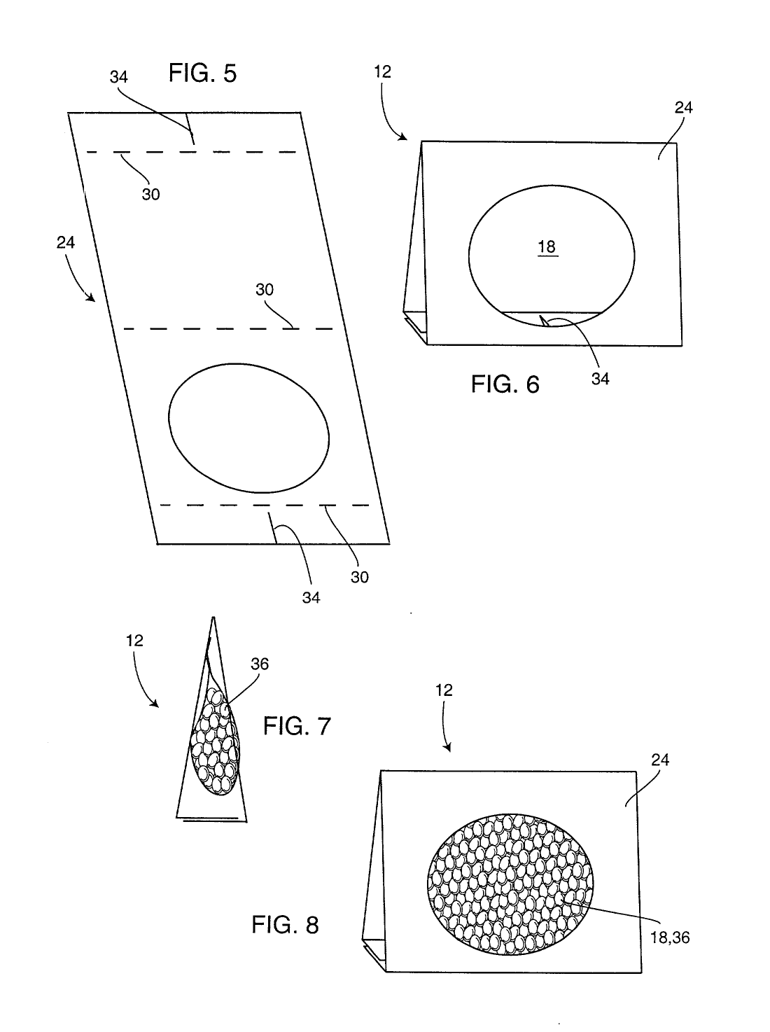

With reference to FIGS. 5 and 6, after the sheet of material 24 has been cut along the cutting markings 28, the sheet of material is then folded along the folded markings 30. This typically creates a three-dimensional greeting card 12. In the illustrated embodiment, small slits 34 were formed at either end of the sheet of material 24 which allow the crafter to interlock the base of the folded card so that it will stand erect when completed.

As illustrated in FIGS. 7 and 8, decorations 36 may be attached to the greeting card 12 to enhance the aesthetic qualities thereof. Such decorations can include cellophane bags filled with candy, potpourri, or the like, pre-formed stamps, ribbons, etc.

Templates 10 can be produced in a variety of designs to produce varying configured folded greeting cards 12. In the illustrated example, a three-dimensional greeting card tent 12 could be created having either an oval or heart window 18 and 20. Other windows, such as a star or square, could be created on other templates 10. Yet other templates 10 may have cutting slits 14 which would create a heart-shaped card, an apron or any other design only limited by the template design. As described above, the template 10 may include other slits, such as small dot apertures (not shown) which would be used to attach portions of the folded material sheet 24 to one another to create other effects, such as pop-out designs and features.

Prior to the availability of the present invention, fifteen to thirty minutes were required to prepare card stock for folding and stamping. This time consuming procedure would at times have to be repeated due to inaccuracies in the cuts and folds. Using the present invention, this procedure can typically be accomplished in less than six minutes, dramatically reducing the time required to produce the folded greeting card 12. Moreover, multiple greeting cards 12 can be produced with precise reproduction. Furthermore, the template 10 can be used as a guide to determine if stamps, stickers, etc. will fit onto the card that the crafter intends to make, allowing the crafter to judge immediately if that stamp can be used in the project.

Although several embodiments have been described in detail for purposes of illustration, various modifications may be made without departing from the scope and spirit of the invention. Accordingly, the invention is not to be limited, except as by the appended claims.

What is claimed is:

1. A process for forming a greeting card, comprising the steps of:
providing a template having a predetermined configuration of slots formed therein, the slots being designated as either folding or cutting slots;
providing a sheet of material;
aligning the template with the sheet of material and forming folding and cutting marks on the sheet of material using the slots in the template;
cutting the sheet of material along the cutting marks formed on the sheet of material; and
folding the sheet of material along the folding marks formed on the sheet of material.

2. The process of claim 1, wherein the configuration of cutting and folding slots formed in the template create a decorative design in the greeting card.

3. The process of claim 1, including the step of forming a three-dimensional greeting card by connecting portions of the folded material sheet to one another.

4. The process of claim 1, including the step of attaching decorations to the cut and folded sheet of material.

5. The process of claim 1, wherein the template is comprised of a reusable material.

6. The process of claim 1, wherein the template includes cutting and folding slots for multiple greeting card designs.

7. A process for forming a greeting card, comprising the steps of:
providing a template having a predetermined configuration of slots formed therein which create a decorative design in the greeting card;
providing a sheet of material;
aligning the template with the sheet of material and forming folding and cutting marks on the sheet of material using the slots in the template;
cutting the sheet of material along the cutting marks formed on the sheet of material;
folding the sheet of material along the folding marks formed on the sheet of material; and
forming a three-dimensional greeting card by connecting portions of the folded material sheet to one another.

8. The process of claim 7, including the step of attaching decorations to the cut and folded sheet of material.

9. The process of claim 7, wherein the template is comprised of a reusable material.

10. The process of claim 7, wherein the template includes cutting and folding slots for multiple greeting card designs.

11. A process for forming a greeting card, comprising the steps of:
providing a template having a predetermined configuration of slots formed therein for multiple greeting card designs, the slots being designated as either folding or cutting slots;
providing a sheet of material;
aligning the template with the sheet of material and forming folding and cutting marks on the sheet of material using the slots in the template;
cutting the sheet of material along the cutting marks formed on the sheet of material;
folding the sheet of material along the folding marks formed on the sheet of material; and
attaching decorations to the cut and folded sheet of material.

12. The process of claim 11, wherein the configuration of cutting and folding slots formed in the template create a decorative design in the greeting card.

13. The process of claim 11, including the step of forming a three-dimensional greeting card by connecting portions of the folded material sheet to one another.

14. The process of claim 11, wherein the template is comprised of a reusable material.
